(19) United States
(12) Patent Application Publication
(10) Pub. No.: US 2015/0026018 A1
(43) Pub. Date: Jan. 22, 2015

(54) INFORMATION PROCESSING APPARATUS AND INFORMATION PROCESSING METHOD

(71) Applicant: TOSHIBA TEC KABUSHIKI KAISHA, Tokyo (JP)

(72) Inventors: Shigeki Nimiya, Yokohama-shi (JP); Takashi Shibuya, Mishima-shi (JP); Youji Tsunoda, Izunokuni-shi (JP); Masatsugu Fukuda, Kannami-chou (JP)

(21) Appl. No.: 14/332,797

(22) Filed: Jul. 16, 2014

(30) Foreign Application Priority Data
Jul. 16, 2013 (JP) 2013-147991
Apr. 17, 2014 (JP) 2014-085914

(51) Int. Cl. G06Q 30/06; G06K 9/62

(52) U.S. Cl. CPC G06Q 30/0643; G06K 9/6202
USPC 705/27.2

(57) ABSTRACT

An information processing apparatus comprises an extraction module configured to extract a feature amount from an image of a commodity captured by an image capturing module; a calculation module configured to compare the feature amount of each commodity registered in a dictionary in association with instruction information instructing whether or not to execute automatic determination with the feature amount extracted by the extraction module to calculate a similarity degree therebetween; a recognition module configured to recognize a commodity of which the similarity degree is higher than a threshold value as a commodity candidate from the commodities registered in a dictionary; a determination module configured to determine the instruction information associated with the commodity candidate; and a display control module configured to selectably display each commodity candidate recognized by the recognition module if it is determined that the instruction information instructing not to execute the automatic determination is associated.

### CROSS-REFERENCE TO RELATED APPLICATION

The present application is based upon and claims the benefit of priorities from Japanese Patent Application No. 2013-147991 filed on Jul. 16, 2013 and Japanese Patent Application No. 2014-085914 filed on Apr. 17, 2014, the entire contents of which are hereby incorporated by reference.

### FIELD

Embodiments described herein relate to an information processing apparatus and an information processing method.

### BACKGROUND

Conventionally, there is a technology which extracts the feature amount of an object from image data obtained by photographing the object and compares the extracted feature amount with pre-prepared data indicating the feature amount of an object for comparison to recognize the category of the object. Moreover, a store system is proposed which applies the technology to recognizing a commodity such as vegetable or fruit to register the sales of the recognized commodity. In the store system, the data (commodity for comparison) of which the similarity degree with a commodity is greater than a threshold value is recognized as a candidate of the commodity. Further, for example, in a case where there is only one data of which the similarity degree with the commodity is greater than the threshold value, the data is automatically determined as the data corresponding to the commodity.

However, in carious commodities, there is a commodity which is easily to be recognized incorrectly due to the characteristic and the like thereof. In this case, if there is only one data of which the similarity degree is higher than the threshold value and the data is an incorrect data, the commodity which is recognized incorrectly is automatically determined, which may lower the efficiency of the processing.

### BRIEF DESCRIPTION OF THE DRAWINGS

FIG. 1 is a perspective view illustrating an external constitution of a checkout system according to an embodiment;

FIG. 2 is a block diagram illustrating hardware constitution of a POS terminal and a commodity reading apparatus shown in FIG. 1;

FIG. 3 is a diagram schematically illustrating one example of data constitution of a PLU file shown in FIG. 2;

FIG. 4 is a diagram schematically illustrating one example of data constitution of a group setting file shown in FIG. 2;

FIG. 5 is a block diagram illustrating functional components of the POS terminal and the commodity reading apparatus shown in FIG. 1;

FIG. 6 is a diagram illustrating an example of the display of a confirmation screen;

FIG. 7 is a diagram illustrating an example of the display of a commodity candidate screen;

FIG. 8 is a flowchart illustrating a procedure of a commodity recognition processing executed by the commodity reading apparatus;

FIG. 9 is a flowchart illustrating a procedure of a sales registration processing executed by the POS terminal;

FIG. 10 is a perspective view illustrating the constitution of a self-checkout POS according to the embodiment; and

FIG. 11 is a block diagram illustrating hardware constitution of the self-checkout POS shown in FIG. 10.

### DETAILED DESCRIPTION

In accordance with one embodiment, an information processing apparatus comprises an extraction module, a calculation module, a recognition module, a determination module and a display control module. The extraction module extracts a feature amount from an image of a commodity captured by an image capturing module. The calculation module compares the feature amount of each commodity registered in a dictionary in association with instruction information instructing whether or not to execute an automatic determination with the feature amount extracted by the extraction module to calculate a similarity degree therebetween. The recognition module recognizes a commodity of which the similarity degree is higher than a threshold value as a commodity candidate from the commodities registered in a dictionary. The determination module determines the instruction information associated with the commodity candidate. The display control module displays each commodity candidate recognized by the recognition module in a selectable manner if it is determined that the instruction information instructing not to execute the automatic determination is associated.

Hereinafter, taking a checkout system as an example, an information processing apparatus and program according to the present embodiment are described with reference to the accompanying drawings. A store system is a checkout system (POS system) comprising a POS terminal for registering and settling commodities in one transaction. The present embodiment is an example of application to a checkout system introduced to a store such as a supermarket and the like.

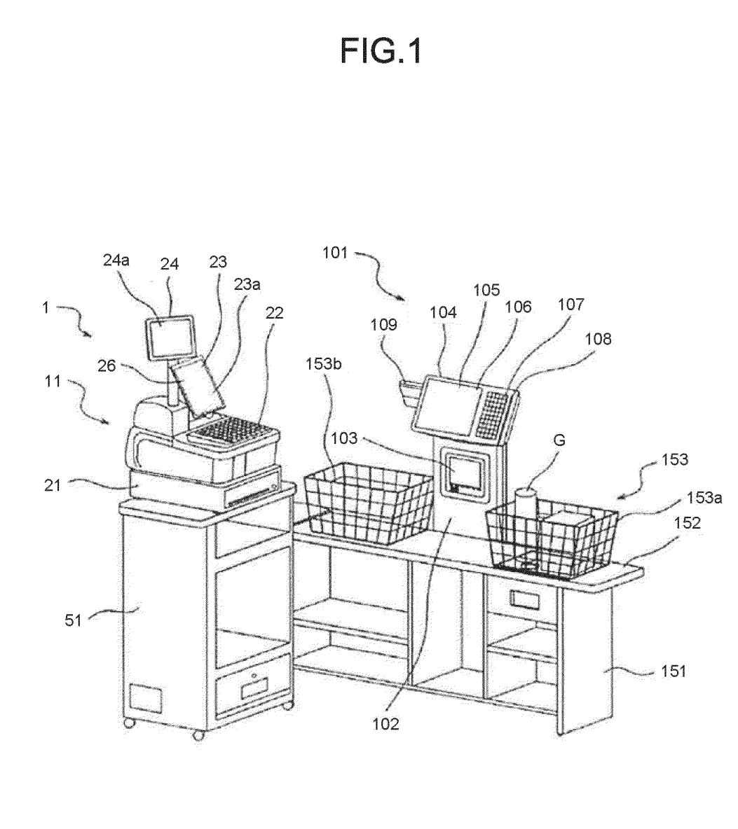

FIG. 1 is a perspective view illustrating an external constitution of a checkout system 1. As shown in FIG. 1, the checkout system 1 comprises a POS terminal 11 and a commodity reading apparatus 101 serving as an information processing apparatus.

The POS terminal 11 is placed on a drawer 21 on a checkout counter 51. The drawer 21 is opened or closed under the control of the POS terminal 11. A keyboard 22 is arranged on the upper surface of the POS terminal 11 for an operator (shop clerk) to operate the POS terminal 11. A display device 23 for displaying information to the operator is arranged at a position opposite to the operator with respect to the keyboard 22. The display device 23 displays information on a display screen 23a thereof. A touch panel 26 is laminated on the display screen 23a. A display for customer 24 is vertically arranged to be rotatable at a backside to the display device 23. The display for customer 24 displays information on a display screen 24a thereof.

The display for customer 24 shown in FIG. 1 is in a state in which the display screen 24a thereof faces the operator in FIG. 1, however, the display for customer 24 can be rotated such that the display screen 24a is directed to a customer to display information to the customer.

A horizontally elongated counter table 151 is arranged to be in an L-shape with the checkout counter 51 on which the POS terminal 11 is placed. A commodity receiving surface 152 is formed on the counter table 151. Shopping basket 153 which receives a commodity G therein is placed on the commodity receiving surface 152. It can be considered to classify the shopping basket 153 into a first shopping basket 153a held by a customer and a second shopping basket 153b placed facing the first shopping basket 153a across the commodity reading apparatus 101.

The commodity reading apparatus 101, which is connected with the POS terminal 11 to be capable of sending and receiving data, is arranged on the commodity receiving surface 152 of the counter table 151. The commodity reading apparatus 101 comprises a thin rectangular housing 102.

A reading window 103 is arranged at the front side of the housing 102. A display and operation section 104 is installed on the upper portion of the housing 102. A display device 106 such as a liquid crystal display device on the surface of which a touch panel 105 is laminated is arranged on the display and operation section 104. A keyboard 107 is arranged at the right side of the display device 106. A card reading slot 108 of a card reader (not shown) is arranged at the right side of the keyboard 107. A display for customer 109 is arranged at the left side of the display and operation section 104.

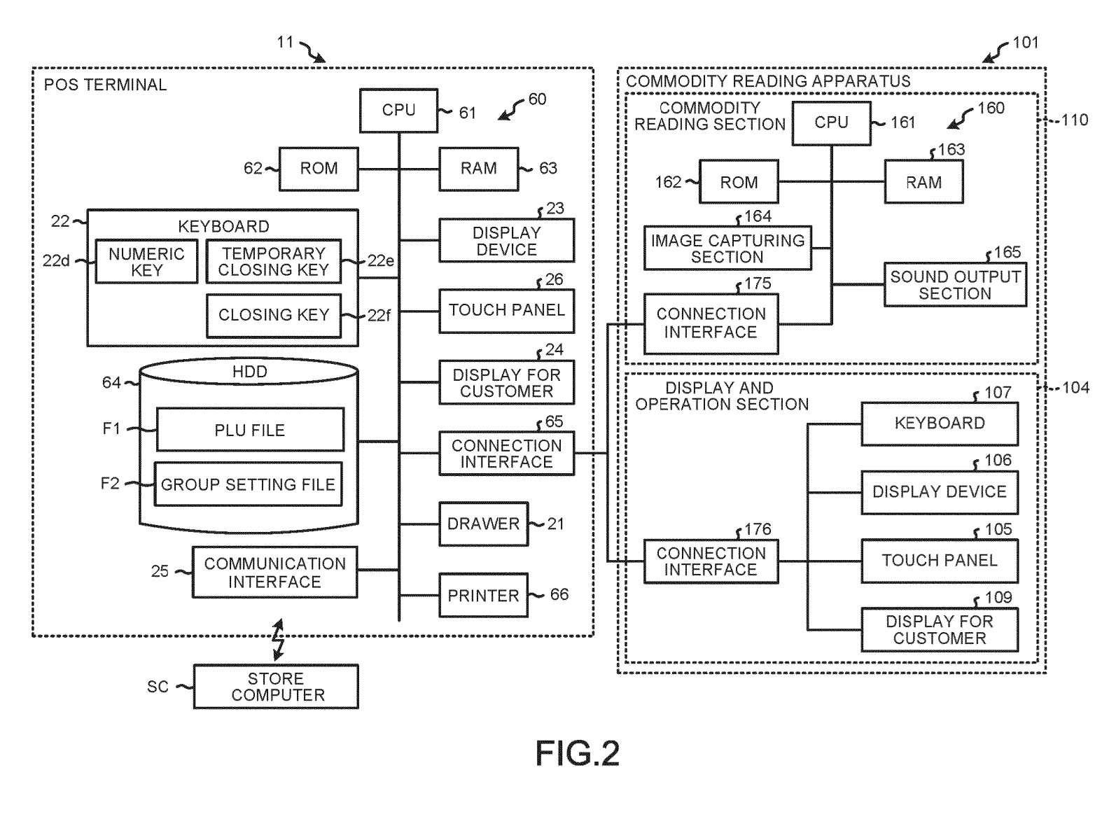

Commodities G purchased in one transaction are put in the first shopping basket 153a held by a customer. The commodities G in the first shopping basket 153a are moved one by one to the second shopping basket 153b by the operator who operates the commodity reading apparatus 101. During the movement, the commodity G is directed to the reading window 103 of the commodity reading apparatus 101. At this time, an image capturing section 164 (referring to FIG. 2) arranged in the reading window 103 captures an image of the commodity G.

FIG. 2 is a block diagram illustrating the hardware constitution of the POS terminal 11 and the commodity reading apparatus 101.

The POS terminal 11 comprises a microcomputer 60 serving as an information processing section for executing information processing. The microcomputer 60 comprises a CPU (Central Processing Unit) 61 which executes various arithmetic processing and controls each section, a ROM (Read Only Memory) 62 and a RAM (Random Access Memory) 63. The ROM 62 stores programs executed by the CPU 61.

The drawer 21, the keyboard 22, the display device 23, the display for customer 24, a communication interface 25, the touch panel 26, a HDD (Hard Disk Drive) 64, a connection interface 65 and a printer 66 are all connected with the CPU 61 of the POS terminal 11 via various input/output circuits (not shown).

The keyboard 22 includes numeric keys 22d on which numeric characters such as ‘1’, ‘2’, ‘3’ . . . and operators such as multiplying operator ‘*’ are displayed, a temporary closing key 22e and a closing key 22f.

The HDD 64 stores various programs and files. When the POS terminal 11 is started, the programs stored in the HDD 64 are all or partially developed on the RAM 63 and executed by the CPU 61.

The HDD 64 stores data files such as a PLU file F1, a group setting file F2 and the like. The PLU file F1 and the group setting file F2 are readable from the commodity reading apparatus 101 via the connection interface 65.

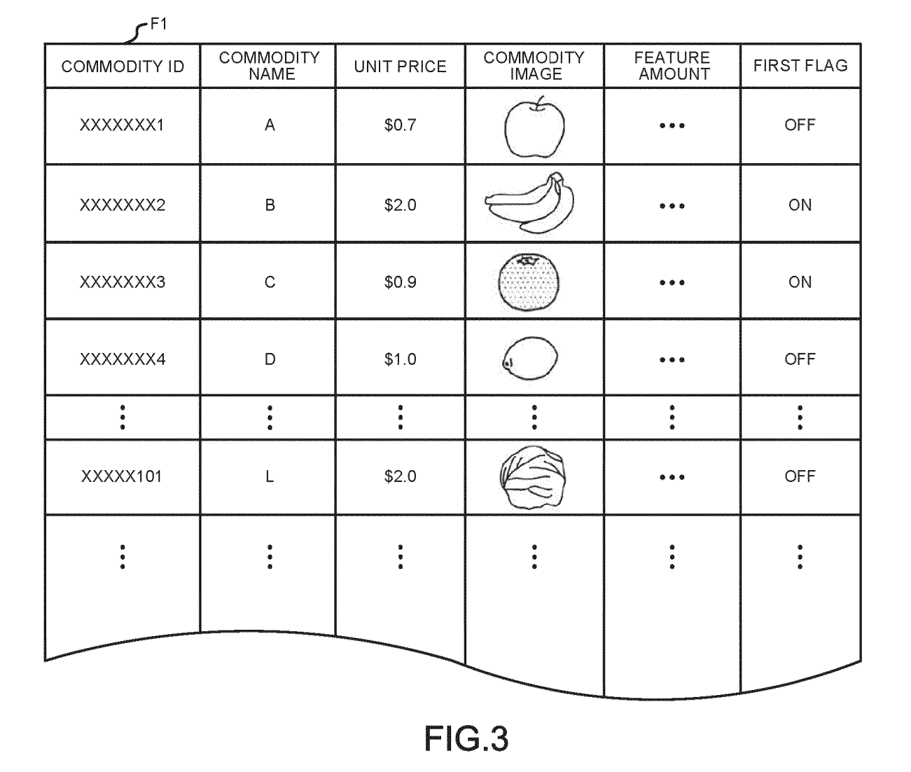

The PLU file F1 is a data file in which a commodity G sold in the store is associated with information relating to the sales registration of the commodity G. FIG. 3 is a diagram schematically illustrating an example of the data constitution of the PLU file F1. As shown in FIG. 3, a commodity ID uniquely assigned to each commodity G, information relating to a commodity such as a commodity name and a unit price, and a commodity image obtained by photographing the commodity G, for each commodity are registered in association with one another in the PLU file F1. Further, in the PLU file F1, appearance feature amount of the commodity G (feature amount data of a commodity registered in a dictionary) is also registered in association with each commodity G. Moreover, a first flag serving as instruction information instructing whether or not to carry out automatic determination of recognition is registered in the PLU file F1 in association with each commodity G.

In the present embodiment, the feature amount data of the PLU file F11 functions as a dictionary (dictionary data) for storing the appearance feature amount of the commodity G. The present invention is not limited to the embodiment, and the dictionary data may be arranged separately from the PLU file F1 for storing the information relating to a commodity such as the commodity ID, commodity name, unit price and the like. In this case, the dictionary data and other data in the PLU file are associated with each other for the same commodity.

The commodity image is obtained by photographing each commodity, which is registered in a dictionary and is to be compared, at the time of similarity degree determination described later. The commodity image is indicated as an image showing the commodity candidate at the time of indication of a commodity candidate described later. Further, the feature amount of a commodity G pre-extracted from the captured image (for example, a commodity image) of each commodity G is registered in association with corresponding commodity ID. Herein, the feature amount refers to the information representing the feature of the commodity G such as the hue, pattern, concave-convex state, shape and the like of the surface of a commodity G.

In the present embodiment, the feature amount of each commodity G is registered in the PLU file F1 in advance, however, it is not limited to this, and the feature amount may be not registered. In this case, the feature amount may be extracted from each commodity image by a feature amount extraction section 1613 described later to obtain the feature amount. Further, instead of a commodity image, an image for indication may also be registered. Hereinafter, each commodity registered in the PLU file F1 is referred to as a “registration commodity”.

The first flag, which is set for each commodity G, is used to individually determine whether or not to carry out the automatic determination of recognition for each of the commodities G. In a case where there is only one registration commodity of which the similarity degree is higher than a threshold value in the similarity degree determination of a similarity degree determination section 1614 described later, the “automatic determination of recognition” means automatically determining the commodity as the determined commodity. In the first flag, whether or not to carry out the automatic determination of recognition by the similarity degree determination section 1614 can be set as two setting values such as “ON” and “OFF”. It is preferred to set to execute (ON) the automatic determination for the registration commodity of which the success rate of recognition is greater than a given value. Herein, though no specific limitation is given to the threshold value relating to the success rate of recognition, it is preferred to be a value indicating a high accuracy, for example, 80% or more.

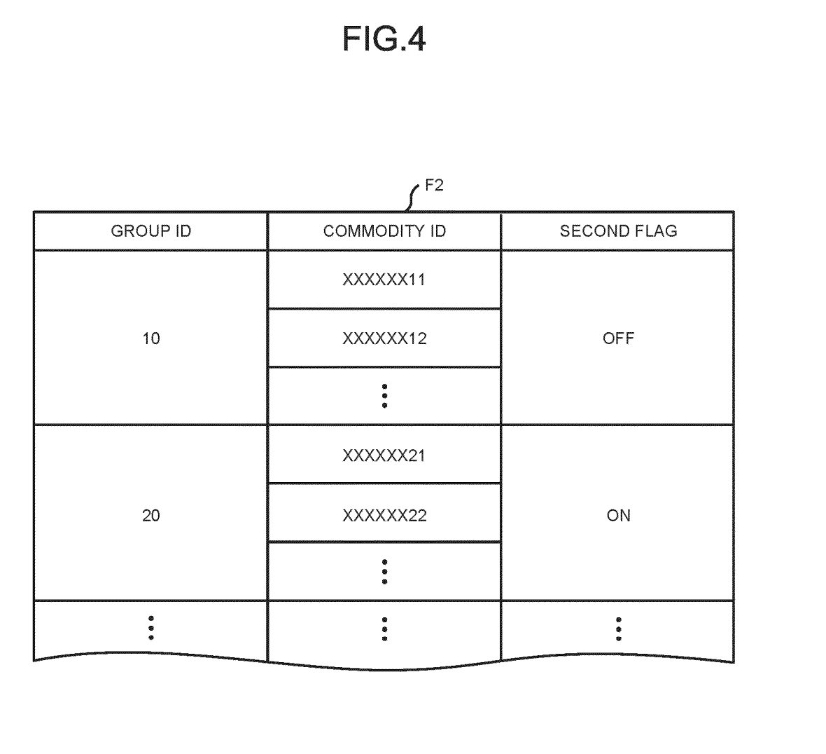

The group setting file F2 is a data file for managing the registration commodities having a specific relationship as members belonging to the same group. FIG. 4 is a diagram schematically illustrating one example of the data constitution of the group setting file F2. As shown in FIG. 4, a group ID uniquely assigned to each group and a commodity ID of the registration commodity belonging to the group are registered in the group setting file F2 in an associated manner. Further, a second flag serving as instruction information instructing whether or not to carry out automatic determination of recognition is registered in the group setting file F2 in association with each group.

In the group setting file F2, no specific limitation is given to the combination of the registration commodities as one same group. For example, in a case where there is a plurality of sales forms for one commodity, the commodity ID assigned to each sales form may be classified into the same group. In this case, for example, the same commodity sold at one unit or sold in a state of being cut into ½ or ¼ may be classified into the same group. Further, the commodity IDs of the registration commodities belonging to the same category or type may be classified into the same group. In this case, for example, each category categorized as a category having a name of “apple” may be classified into the same group. Even for the different registration commodities, the registration commodities similar in appearance feature may be classified into the same group. In this case, for example, the registration commodities which may be recognized incorrectly in the commodity candidate recognition described later may be classified into the same group.

The second flag, which is set for each group, is used to uniformly determine whether or not to carry out the automatic determination of recognition for each of the registration commodities belonging to the group. It is preferred to set to execute (ON) the automatic determination for the group consisting of registration commodities of which the success rate of recognition is greater than a given value (for example, 80% or more).

Returning to FIG. 2, the communication interface 25 for executing data communication with a store computer SC is connected with the CPU 61 of the POS terminal 11 through the input/output circuit (not shown). The store computer SC is arranged at a backyard and the like in a store. The HDD (not shown) of the store computer SC stores the PLU file F1 and the group setting file F2 sent to the POS terminal 11, a stock management file for managing the stock state of each registration commodity in the PLU file F1, and the like.

The connection interface 65 enables the data transmission/reception with the commodity reading apparatus 101. The commodity reading apparatus 101 is connected with the connection interface 65. A receipt printer 66 is provided in the POS terminal 11. The POS terminal 11 prints content of one transaction on a receipt with the receipt printer 66 under the control of the CPU 61.

The commodity reading apparatus 101 comprises a commodity reading section 110 and the display and operation section 104. The commodity reading section 110 comprises a microcomputer 160. The microcomputer 160 comprises a CPU 161, a ROM 162 and a RAM 163. The ROM 162 stores programs executed by the CPU 161.

The image capturing section 164, a sound output section 165 and a connection interface 175 are connected with the CPU 161 through various input/output circuits (not shown) . The operations of the image capturing section 164, the sound output section 165 and the connection interface 175 are controlled by the CPU 161.

The image capturing section 164, which is a color CCD sensor or a color CMOS sensor and the like, is an image capturing module for carrying out an image capturing processing through the reading window 103. For example, motion images are captured by the image capturing section 164 at 30 fps. The frame images (captured images) sequentially captured by the image capturing section 164 at a given frame rate are stored in the RAM 163. The sound output section 165 includes, for example, a sound circuit and a speaker for issuing a preset alarm sound and the like. The sound output section 165 gives a notification through a sound such as an alarm sound under the control of the CPU 161.

The display and operation section 104 comprises the touch panel 105, the display device 106, the keyboard 107, the display for customer 109 and a connection interface 176. The connection interface 175 of the commodity reading section 110, which is connected with the connection interface 65 of the POS terminal 11, enables the data transmission/reception with the POS terminal 11. The connection interface 175 connects with the display and operation section 104 through the connection interface 176, and the CPU 161 carries out data transmission/reception between the commodity reading section 110 and the display and operation section 104 through the connection interface 175.

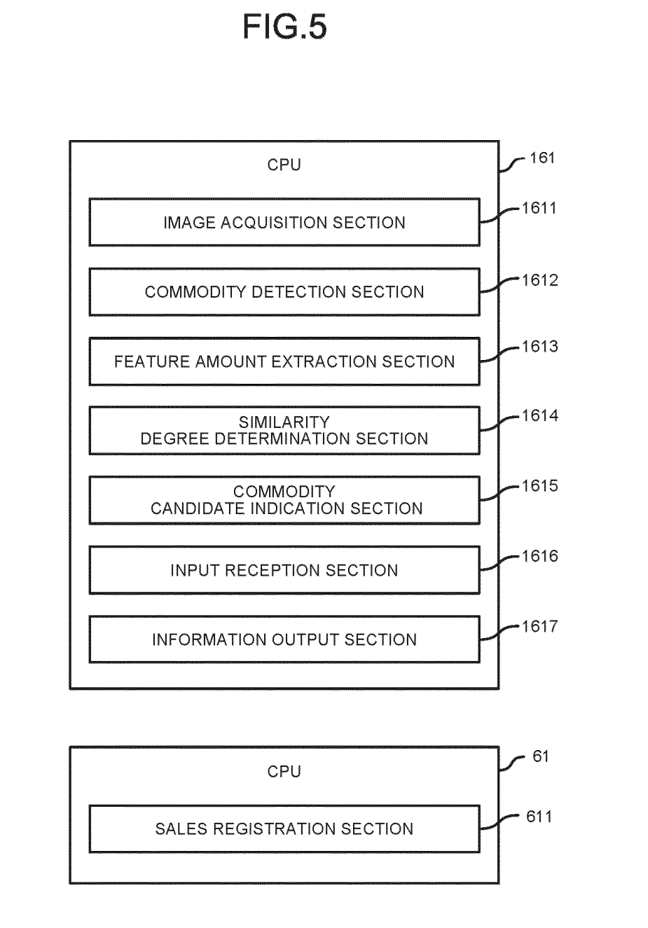

Next, the functional components of the CPU 161 and the CPU 61 realized by executing the programs by the CPU 161 and the CPU 61 are described below with reference to FIG. 5.

FIG. 5 is a block diagram illustrating the functional components of the POS terminal 11 and the commodity reading apparatus 101. As shown in FIG. 5, the CPU 161 of the commodity reading apparatus 101 executes programs sequentially to function as an image acquisition section 1611, a commodity detection section 1612, a feature amount extraction section 1613, a similarity degree determination section 1614, a commodity candidate indication section 1615, an input reception section 1616 and an information output section 1617.

The image acquisition section 1611 is a functional section corresponding to an acquisition module. The image acquisition section 1611 outputs an ON-signal of image capturing to the image capturing section 164 to enable the image capturing section 164 to start an image capturing operation. The image acquisition section 1611 sequentially acquires the captured images which are captured by the image capturing section 164 after the image capturing operation is started and are stored in the RAM 163. The image acquisition section 1611 acquires the captured images from the RAM 163 in the order of storing them to the RAM 163.

The commodity detection section 1612 detects the whole or part of the contour line of a commodity G contained in the captured image acquired by the image acquisition section 1611 using a known pattern matching technology. Next, by comparing the contour line extracted from the last time captured image (frame image) with the contour line extracted from the current frame image (next to the last time), a different part, that is, a reflection image area of a commodity G directed to the reading window 103 is detected.

As another method for detecting a commodity G, it is determined whether or not a flesh color area is detected from the captured image. If the flesh color area is detected, that is, the reflection image of the hand of a shop clerk is detected, the detection of the aforementioned contour line nearby the flesh color area is carried out to try to extract the contour line of the commodity G that is assumed to be held by the shop clerk. At this time, if a contour line representing the shape of a hand and the contour line of another object nearby the contour line of the hand are detected, the commodity G is detected from the contour line of the object.

The feature amount extraction section 1613 is a functional section corresponding to an extraction module. The feature amount extraction section 1613 extracts the surface state (surface hue, pattern, concave-convex state, shape and the like) of the commodity G detected by the commodity detection section 1612 from the captured image acquired by the image acquisition section 1611 as a feature amount.

The similarity degree determination section 1614 is a functional section corresponding to a calculation module, a recognition module and a determination module. The similarity degree determination section 1614 compares the feature amount of each registration commodity in the PLU file F1 of the POS terminal 11 with the feature amount extracted by the feature amount extraction section 1613 to calculate the similarity degree therebetween. Further, the similarity degree determination section 1614 recognizes, in the registration commodities the similarity degrees of which are calculated, the registration commodity (commodity ID) of which the similarity degree is higher than a given threshold value as a candidate (commodity candidate) of the commodity G photographed by the image capturing section 164.

Herein, the similarity degree may be a value (similarity degree), which is obtained by comparing the feature amount of the commodity G with the feature amount of each commodity registered in the PLU file F1, representing how much similar the two feature amounts are. The concept of the similarity degree is not limited to the example above. The similarity degree may be a value representing the degree of coincidence with the feature amount of each registration commodity in the PLU file F1, or a value representing the degree of correlation between the feature amount of the commodity G and the feature amount of each registration commodity in the PLU file F1.

The recognition of an object contained in an image as stated above is referred to as a general object recognition. As to the general object recognition, various recognition technologies are described in the following document.

Keiji Yanai “Present situation and future of generic object recognition”, Journal of Information Processing Society, Vol. 48, No. SIG16 [Search on Heisei 25 January 24], Internet<URL: http://mm.cs.uec.ac.jp/IPSJ-TCVIM-Yanai.pdf>

In addition, the technology carrying out the general object recognition by performing an area-division on the image for each object is described in the following document.

Jamie Shotton etc, “Semantic Texton Forests for Image Categorization and Segmentation”, [Search on Heisei 25 January 24], Internet <URL: http://cite seerx.ist psu.edu/viewdoc/download?doi=10.1.1.145.3036&rep=rep1&type=pdf>

In addition, no limitation is given to the method for calculating the similarity degree. For example, the similarity degree can be calculated as an absolute evaluation or a relative evaluation. If the similarity degree is calculated as an absolute evaluation, the captured image of the commodity G and each of the registered commodities are compared one by one, and the similarity degree obtained from the comparison result can be adopted as it is . If the similarity degree is calculated as a relative evaluation, the similarity degree is obtained as long as the sum of the similarity degrees between the captured commodity G and each registration commodity becomes 1.0 (100%).

The similarity degree determination section 1614 determines the first flag of a commodity candidate having the highest similarity degree within the recognized commodity candidates by reference to the PLU file F1. Herein, if the execution (ON) of the automatic determination is set in the first flag, the similarity degree determination section 1614 determines the commodity candidate having the highest similarity degree as the commodity (determined commodity) corresponding to the commodity G. If the non-execution (OFF) of the automatic determination is set, the similarity degree determination section 1614 determines the second flag of the group to which the commodity candidate having the highest similarity degree belongs by reference to the group setting file F2. Herein, if the execution (ON) of the automatic determination is set in the second flag, the similarity degree determination section 1614 determines the commodity candidate having the highest similarity degree as the commodity (determined commodity) corresponding to the commodity G.

In the present embodiment, the “commodity candidate having the highest similarity degree” is not limited to be one of the plurality of recognized commodity candidates, and if only one commodity candidate is recognized, the recognized commodity candidate is also taken into consideration. In addition, if there is a plurality of commodity candidates having the highest similarity degrees, any one of the commodity candidates may be determined as the determined commodity, alternatively, the automatic recognition is not carried out and all the recognized commodity candidates are notified to the commodity candidate indication section 1615.

In the present embodiment, it is exemplified that the first flag and the second flag of the commodity candidate having the highest similarity degree are determined, however, the present invention is not limited to this. For example, the determination on the first flag and the second flag may be carried out on condition that the difference between the similarity degree of the commodity candidate having the highest similarity degree and the similarity degree of other commodity candidate different from the commodity candidate having the highest similarity degree is higher than a given value.

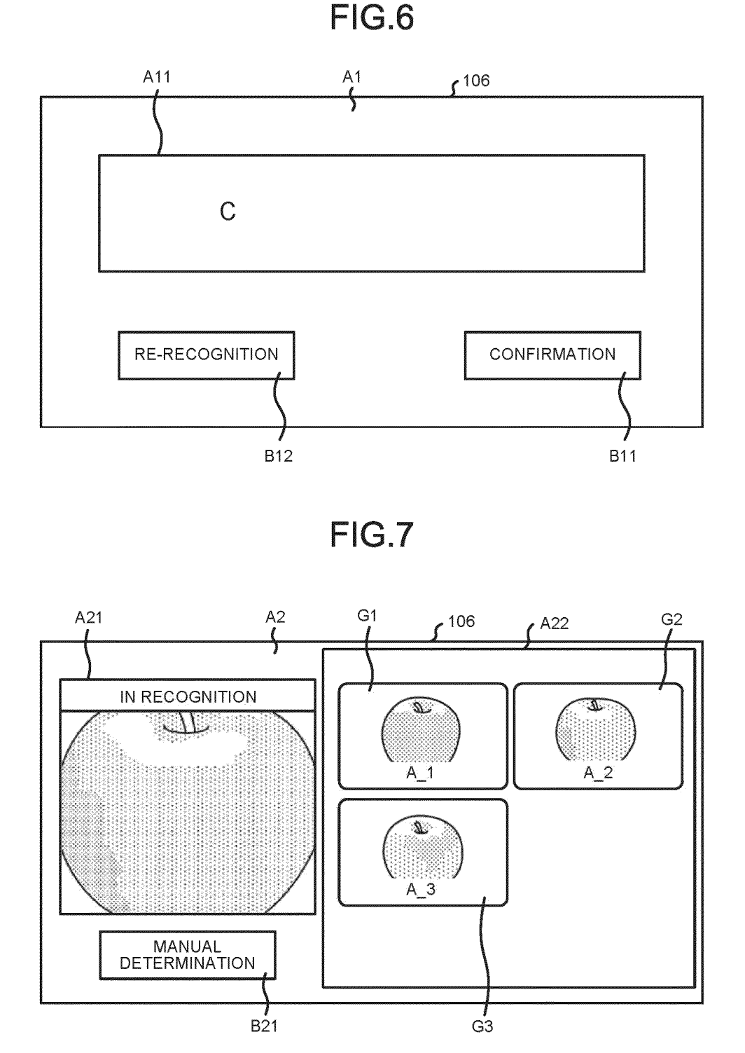

After the similarity degree determination section 1614 determines the determined commodity, a confirmation screen for notifying the operator of the determined commodity is displayed on the display device 106. Herein, FIG. 6 is a diagram illustrating an example of the display of the confirmation screen. As shown in FIG. 6, a confirmation screen A1 contains a determined commodity indication area A11 for displaying the commodity name and the like of the determined commodity. The confirmation screen A1 further contains a confirmation button B11 for confirming the consent to the determined commodity and a re-recognition button B12 for instructing the re-recognition processing.

Herein, the operator confirms the determined commodity displayed in the determined commodity indication area A11, and operates, if the content is correct, the confirmation button B11 to notify of the recognition success. If the operation of the confirmation button B11 is received, the similarity degree determination section 1614 records that the recognition on the determined commodity (commodity ID) is successful.

If there is an error in the determined commodity displayed in the determined commodity indication area A11, the operator operates the re-recognition button B12 to notify of the occurrence of incorrect recognition. If the operation on the re-recognition button B12 is received, the similarity degree determination section 1614 records that the recognition of the determined commodity (commodity ID) is incorrect. Then, the similarity degree determination section 1614 restarts the similarity degree determination to carryout re-recognition of the commodity candidate. During the re-recognition processing, it is assumed that the non-execution of the automatic determination is set in the first flag and the second flag. If the reading of the new commodity G is confirmed, or if a given time (for example, two seconds) elapses, it is assumed that the confirmation button B11 is operated.

If the non-execution (OFF) of the automatic determination is set in the first flag and the second flag, the similarity degree determination section 1614 notifies the commodity candidate indication section 1615 of all the recognized commodity candidates without carrying out the determination processing.

The commodity candidate indication section 1615 is a functional section corresponding to a display control module. The commodity candidate indication section 1615 displays the information relating to the registration commodity notified as a commodity candidate from the similarity degree determination section 1614 on the display device 106. More specifically, the commodity candidate indication section 1615 reads the record of the registration commodity corresponding to the commodity candidate from the PLU file F1 of the POS terminal 11, and displays it on the display device 106.

FIG. 7 is a diagram illustrating an example of the display of a commodity candidate screen. As shown in FIG. 7, a commodity candidate screen A2 includes a captured image area A21 and a commodity candidate indication area A22.

The captured image area A21 is an area for displaying the captured image acquired by the image acquisition section 1611. The commodity candidate indication area A22 is an area for displaying the commodity image and the commodity name and the like of each registration commodity recognized as a commodity candidate. Commodity images (G1-G3) as well as the commodity names and the like of the commodity candidates recognized by the similarity degree determination section 1614 are displayed in the commodity candidate indication area A22. In addition, it is also applicable to only display the commodity names of the commodity candidates recognized by the similarity degree determination section 1614 in the commodity candidate indication area A22 without displaying the commodity images.

A manual determination button B21 for manually selecting (determining) a commodity from a department code or a commodity list and the like is arranged below the captured image area A21. The CPU 161 displays a manual determination screen (not shown) for manually carrying out commodity determination on the display device 106 in response to the operation of the manual determination button B21. The commodity (registration commodity) selected from the manual determination screen is processed as a determined commodity.

The commodity candidate displayed in the commodity candidate indication area A22 is not limited to the candidates notified from the similarity degree determination section 1614. For example, in a case where the commodity candidates notified from the similarity degree determination section 1614 belong to one group, the other registration commodities belonging to the group may also be displayed in the commodity candidate indication area A22 as the commodity candidates. In this case, the commodity candidate indication section 1615 specifies the group to which the commodity IDs of the notified commodity candidates belong from the group setting file F2. Then, the commodity candidate indication section 1615 reads the record of the registration commodity belonging to the specified group from the PLU file F1 and displays it in the commodity candidate indication area A22 as the commodity candidate.

Returning to FIG. 5, the input reception section 1616 receives various input operations corresponding to the display of the display device 106 through the touch panel 105 or the keyboard 107. For example, the input reception section 1616 receives a selection operation of one commodity candidate from the commodity candidates displayed on the display device 106. The input reception section 1616 determines the selected commodity candidate as the commodity (determined commodity) corresponding to the commodity G. In a case where the commodity detection section 1612 has a capability of detecting a plurality of commodities G, the input reception section 1616 may receive selection operations of a plurality of commodity candidates from the commodity candidates.

The information output section 1617 outputs the information (for example, the commodity ID, the commodity name and the like) indicating the commodity determined in the aforementioned manner to the POS terminal 11 through the connection interface 175.

The information output section 1617 may also output the sales volume input separately through the touch panel 105 or the keyboard 107 to the POS terminal 11 together with the commodity ID and the like. As to the information output to the POS terminal 11 by the information output section 1617, the information output section 1617 may directly notify of the commodity ID read from the PLU file F1, or the commodity name, file name of the commodity image capable of specifying the commodity ID may be notified, or the storage location of the commodity ID (storage address in the PLU file F1) may be notified.

On the other hand, the CPU 61 of the POS terminal 11 has a function of a sales registration section 611 by executing programs. The sales registration section 611 carries out a sales registration of a corresponding commodity based on the commodity ID and the sales volume output from the information output section 1617 of the commodity reading apparatus 101. Specifically, the sales registration section 611 carries out, with reference to the PLU file F1, a sales registration by recording the notified commodity ID and the commodity category, commodity name and unit price specified with the commodity ID in a sales master file together with the sales volume.

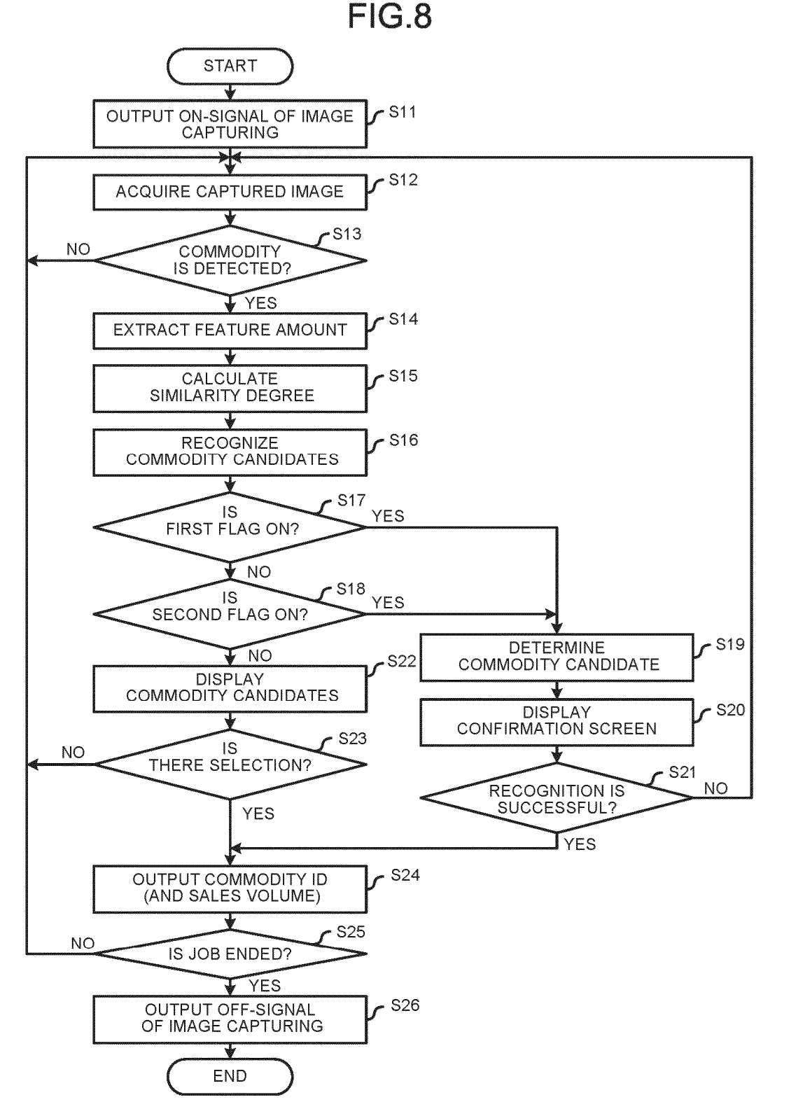

Hereinafter, the operations of the checkout system 1 are described. First, the operations of the commodity reading apparatus 101 are described with reference to FIG. 8. FIG. 8 is a flowchart illustrating the procedure of the commodity recognition processing executed by the commodity reading apparatus 101.

When the processing is started in response to a start of the commodity registration by the POS terminal 11, the image acquisition section 1611 outputs an ON-signal of image capturing to the image capturing section 164 to enable the image capturing section 164 to start an image capturing operation (ACT S11)

The image acquisition section 1611 acquires a frame image (captured image) that the image capturing section 164 captures and stores in the RAM 163 (ACT S12). Next, the commodity detection section 1612 detects the whole or part of the commodity G from the captured image acquired in ACT S12 (ACT S13). Herein, if the commodity G is not detected (NO in ACT S13), the flow returns to ACT S12.

Further, in ACT S13, if the commodity G is detected (YES in ACT S13), the feature amount extraction section 1613 extracts the feature amount of the commodity G detected in ACT S13 from the captured image acquired in ACT S12 (ACT S14). Then the similarity degree determination section 1614 compares the feature amount extracted in ACT S14 with the feature amount of each registration commodity in the PLU file F1 to calculate similarity degrees respectively (ACT S15).

The similarity degree determination section 1614 recognizes the commodity ID of the registration commodity of which the calculated similarity degree is higher than a given threshold value as a commodity candidate (ACT S16). If the number of the commodity candidate is zero, the flow returns to ACT S12.

Next, the similarity degree determination section 1614 determines the setting value of the first flag associated with the commodity candidate having the highest similarity degree within the recognized commodity candidates (ACT S17). If the execution (ON) of the automatic determination is set in the first flag (YES in ACT S17), the similarity degree determination section 1614 determines the commodity candidate having the highest similarity degree as the determined commodity (ACT S19), and then ACT S20 is taken. Though in the present embodiment, if the execution (ON) of the automatic determination is set in the first flag (YES in ACT S17), the similarity degree determination section 1614 determines the commodity candidate having the highest similarity degree as the determined commodity, the present invention is not limited to this. For example, if the execution (ON) of the automatic determination is set in the first flag (YES in ACT S17) , the similarity degree determination section 1614 may select to carry out the automatic determination or to display the commodity candidates according to the threshold value of the similarity degree. For example, if the similarity degree is higher than 90%, the automatic determination is carried out, and if the similarity degree is lower than 90%, the commodity candidate is displayed.

On the other hand, if the non-execution (OFF) is set in the first flag (NO in ACT S17), the similarity degree determination section 1614 determines the setting value of the second flag associated with the group to which the commodity candidate belongs (ACT S18).

If the execution (ON) of the automatic determination is set in the second flag (YES in ACT S18), the similarity degree determination section 1614 determines the commodity candidate as the determined commodity (ACT S19), and then ACT S20 is taken. On the other hand, if the non-execution (OFF) of the automatic determination is set in the second flag (NO in ACT S18), the similarity degree determination section 1614 notifies the commodity candidate indication section 1615 of the commodity candidate, and then ACT S22 is taken.

In ACT S20, the similarity degree determination section 1614 displays the confirmation screen of the determined commodity (ACT S20). Herein, if the confirmation button B11 is operated (YES in ACT S21), the similarity degree determination section 1614 records that the recognition is successful, and then ACT S24 is taken. Further, if the re-recognition button B12 is operated (NO in ACT S21), the similarity degree determination section 1614 records that the recognition is incorrect, and then the flow returns to ACT S12.

In ACT S22, the commodity candidate indication section 1615 reads the record of the notified commodity candidate from the PLU file F1, and displays it on the display device 106. When the commodities in the second flags of which “OFF” state is set are displayed on the display device 106 as the commodity candidates, the background color of the commodity images (for example, G1-G3 in FIG. 7) of the candidates maybe changed. For example, the commodity images are displayed in a distinguishable manner that the background color of the commodity images of the commodities in the second flags of which “OFF” state is set is blue, while the background color of the commodity images of the commodities in the second flags of which “OFF” state is not set is white.

Next, the input reception section 1616 determines whether or not the selection of the commodity candidate is received through the touch panel 105 or the keyboard 107 (ACT S23). If the selection operation is received (YES in ACT S23), the input reception section 1616 receives the selected commodity candidate as the determined commodity corresponding to the commodity G, and then ACT S24 is taken. Further, in ACT S23, if no selection of the commodity candidate is received (NO in ACT S23), ACT S12 is taken again.

In ACT S24, the information output section 1617 outputs the information such as the commodity ID representing the determined commodity to the POS terminal 11 (ACT S24), and then ACT S25 is taken. In a case in which the sales volume is input separately through the touch panel 105 and the like, the sales volume is also output to the POS terminal 11 together with the information representing the determined commodity in ACT S24. If the sales volume is not input, the sales volume “1” may also be output as a default value.

In ACT S25, the CPU 161 determines whether or not the job is ended based on an end notification of the commodity registration from the POS terminal 11 (ACT S25). If the job is continued (NO in ACT S25), the CPU 161 returns to the processing in ACT S12 to continue the processing. If the job is ended (YES in ACT S25) , the image acquisition section 1611 ends the image capturing of the image capturing section 164 by outputting an OFF-signal of image capturing to the image capturing section 164 (ACT S26), then the commodity recognition processing is ended.

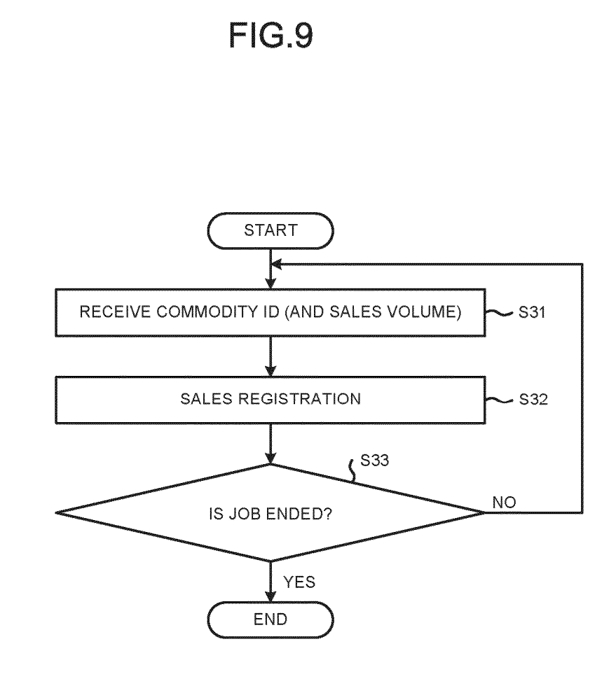

Next, the processing operations of the POS terminal 11 are described. FIG. 9 is a flowchart illustrating the procedure of the sales registration processing executed by the POS terminal 11.

First, when the processing is started in response to a start of the commodity registration according to an operation instruction through the keyboard 22, the CPU 61 receives the commodity ID and the sales volume of the determined commodity output by the commodity reading apparatus 101 in ACT S24 of FIG. 8 (ACT S31). Then, the sales registration section 611 reads the commodity category, the unit price and the like from the PLU file F1 based on the commodity ID and the sales volume received in ACT S31 and registers the sales of the commodity G read by the commodity reading apparatus 101 in the sales master file (ACT S32).

Then, the CPU 61 determines whether or not the job is ended based on an ending of the sales registration according to the operation instruction through the keyboard 22 (ACT S33). If the job is continued (NO in ACT S33), the CPU 61 returns to ACT S31 to continue the processing. If the job is ended (YES in ACT S33), the CPU 61 ends the sales registration processing.

As stated above, in accordance with the present embodiment, the automatic determination of the registration commodity (determined commodity) corresponding to the commodity G is executed based on the setting values of the first flag and the second flag set according to the recognition rate and the like. In this way, if the registration commodity of which the execution of automatic determination is instructed is recognized, the determination of the determined commodity can be carried out automatically, thus, the processing relating to the recognition of commodity can be carried out efficiently. Further, for example, the automatic determination is not executed for the registration commodity of which the occurrence rate of the incorrect recognition is high, but is executed for the other registration commodities, which can improve the accuracy of the automatic determination.

While certain embodiments have been described, these embodiments have been presented by way of example only, and are not intended to limit the scope of the invention. Indeed, the novel embodiments described herein may be embodied in a variety of other forms; furthermore, various omissions, substitutions, changes and additions in the form of the embodiments described herein may be made without departing from the spirit of the invention. The accompanying claims and their equivalents are intended to cover such forms or modifications as would fall within the scope and spirit of the invention.

For example, the setting values of the first flag and the second flag may be fixed values, alternatively, the setting values of the first flag and the second flag may be changed dynamically. In a case of the later constitution, the CPU 161 or the CPU 61 function as setting change modules for changing the setting values of the first flag and the second flag based on the recognition rate of the similarity degree determination section 1614. Specifically, the setting change module calculates the occurrence rate of the incorrect recognition of each commodity candidate based on the record (history) of the recognition success and the incorrect recognition of each commodity candidate (determined commodity) obtained in ACT S21. Then, the setting change module sets (changes) the first flag or the second flag relating to the commodity candidate (registration commodity) of which the success rate of recognition is higher than a given value (for example, higher than 80%) to “ON”. Further, the setting change module sets (changes) the first flag or the second flag relating to the commodity candidate (registration commodity) of which the success rate of recognition is lower than the given value (for example, lower than 80%) to “OFF”.

In the embodiment described above, both the first flag and the second flag are set; however, it is also applicable to set only one of the first flag and the second flag.

In the embodiment described above, though it is exemplified that both the PLU file F1 and the group setting file F2 are included in the POS terminal 11, the present invention is not limited to this, and both or either of the PLU file F1 and the group setting file F2 maybe arranged in the commodity reading apparatus 101.

In the embodiment described above, if it is determined by the determination module (similarity degree determination section 1614) that the instruction information instructing the non-execution of the automatic determination is associated with each commodity, each commodity candidate recognized by the recognition module (similarity degree determination section 1614) is displayed in a selectable manner, however, the present invention is not limited to this. For example, the commodity reading apparatus 101 may also include an operation mode for operating in an automatic determination execution mode or an automatic determination non-execution mode for the commodity of which the execution of automatic determination is instructed.

Herein, the automatic determination execution mode is an operation mode for executing automatic determination for the commodity of which the execution of automatic determination is instructed. When the commodity reading apparatus 101 operates in the automatic determination execution mode, the recognition module (similarity degree determination section 1614) carries out the automatic determination for the commodity of which the execution of automatic determination is instructed, as stated in the aforementioned embodiment.

The automatic determination non-execution mode is an operation mode for not executing the automatic determination for the commodity of which the execution of automatic determination is instructed. When the commodity reading apparatus 101 operates in the automatic determination non-execution mode, the recognition module (similarity degree determination section 1614) notifies the display control module (commodity candidate indication section 1615) of the commodity of which the execution of automatic determination is instructed as the commodity candidate without carrying out the automatic determination. Further, the display control module (commodity candidate indication section 1615) displays each commodity candidate recognized by the recognition module (similarity degree determination section 1614) in a selectable manner.

The commodity reading apparatus 101 (similarity degree determination section 1614) may include the two operation modes itself, that is, the automatic determination execution mode and the automatic determination non-execution mode, regardless of the existence of the instruction information instructing whether or not to execute the automatic determination. In this case, for example, in the automatic determination execution mode, the commodity is automatically determined if the similarity degree is higher than a first threshold value, and each recognized commodity candidate is displayed in a selectable manner if the similarity degree is lower than the first threshold value but higher than a second threshold value (first threshold value>second threshold value). On the other hand, in the automatic determination non-execution mode, the commodity is not automatically determined even if the similarity degree is higher than the first threshold value serving as a threshold value for determining a commodity, and each recognized commodity candidate is displayed in a selectable manner. In this way, in a case where there are commodities which are easily to be recognized incorrectly and commodities which are just registered in a dictionary, the processing relating to the recognition of commodity can be carried out efficiently by setting the operation mode to the automatic determination non-execution mode. Further, a setting change module can be arranged to change (switch between) the automatic determination execution mode and the automatic determination non-execution mode properly.

Further, it is arranged in the embodiment stated above that the recognition of the commodity candidate is carried out in the commodity reading apparatus 101, however, all or part of the functional sections of the commodity reading apparatus 101 may be included in the POS terminal 11.

For example, the POS terminal 11 may comprise the feature amount extraction section 1613 and the similarity degree determination section 1614, while the commodity reading apparatus 101 may comprise the image acquisition section 1611, the commodity detection section 1612, the commodity candidate indication section 1615, the input reception section 1616 and the information output section 1617. In this case, the commodity reading apparatus 101 transmits the captured image, which is acquired by the image acquisition section 1611 and from which the commodity is detected by the commodity detection section 1612, to the POS terminal 11. The commodity reading apparatus 101 receives the result of the commodity (registration commodity) recognized by the POS terminal 11, and indicates the received result as a commodity candidate through the commodity candidate indication section 1615. Further, in a case in which the POS terminal 11 comprises all the functional sections of the commodity reading apparatus 101, the commodity reading apparatus 101 functions as an image capturing apparatus, and the POS terminal 11 carries out the display and the selection of a commodity candidate based on the captured image sent from the commodity reading apparatus 101.

Further, in the embodiment stated above, an example is exemplified where a stationary type scanner apparatus (commodity reading apparatus 101) is used, however, it is not limited to this, and a so-called handy type scanner apparatus connected with the POS terminal 11 may be employed.

Further, according to the embodiment stated above, in a checkout system 1 consisting of the POS terminal 11 and the commodity reading apparatus 101, the present invention is applied to the commodity reading apparatus 101, however, it is not limited to this, and it may also be applied to an apparatus comprising all the functions of the POS terminal 11 and the commodity reading apparatus 101, or a checkout system constituted by, for example, connecting the commodity reading apparatus 101 and the POS terminal 11 shown in FIG. 1 in a wired or wireless manner. As an apparatus comprising all the functions of the POS terminal 11 and the commodity reading apparatus 101, a self-checkout apparatus (hereinafter referred to as a self-checkout POS in short) arranged and used in a store such as a supermarket and the like is listed.

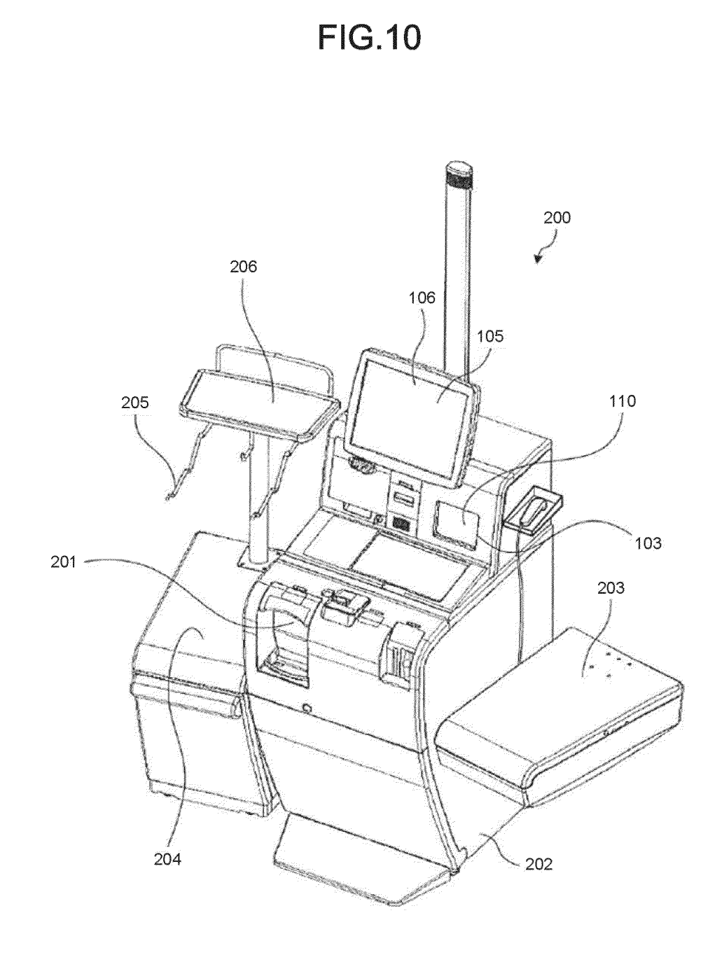

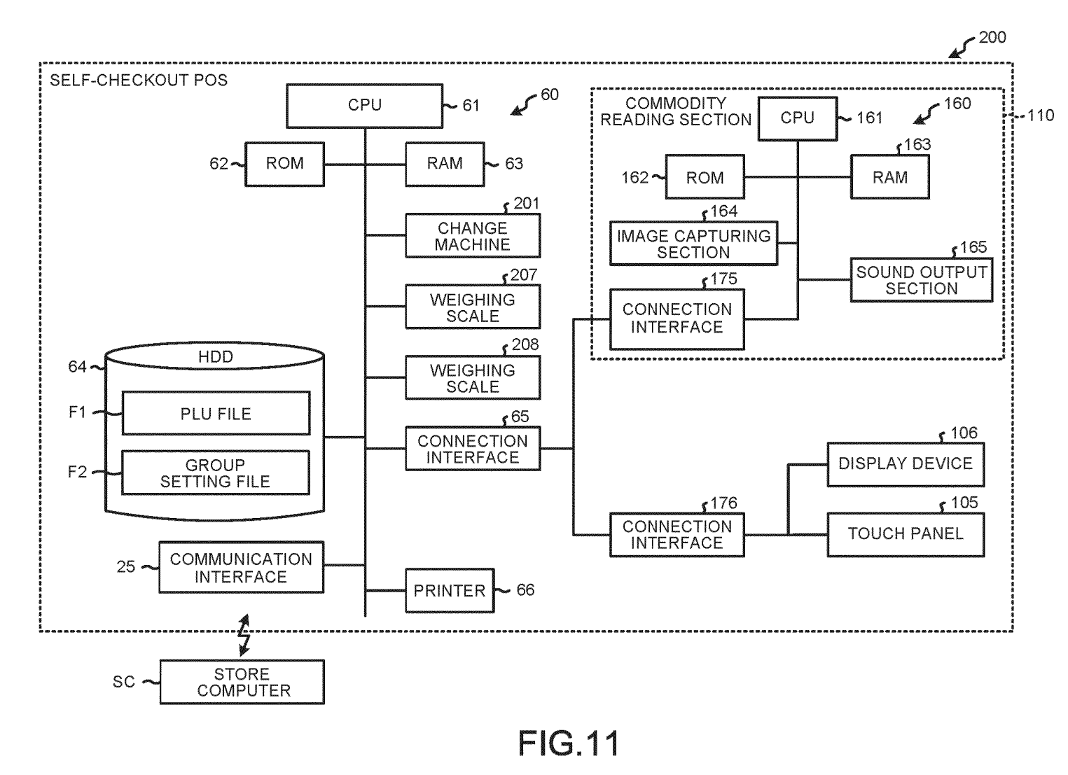

Herein, FIG. 10 is a perspective view illustrating the external constitution of a self-checkout POS 200, and FIG. 11 is a block diagram illustrating the hardware constitution of the self-checkout POS 200. Hereinafter, the same numerals are applied to the components similar to that in FIG. 1 and FIG. 2, and the detailed descriptions thereof are not repeated.

As shown in FIG. 10 and FIG. 11, a main body 202 of the self-checkout POS 200 comprises a display device 106 having a touch panel 105 on the surface thereof and a commodity reading section 110 which reads a commodity image to recognize (detect) the category of a commodity.

The display device 106 displays a guidance screen for providing customers a guidance for the operation of the self-checkout POS 200, various input screens, a registration screen for displaying the commodity information read by the commodity reading section 110 and a settlement screen, on which a total amount, a deposit amount and a change amount are displayed and through which a payment method can be selected.

The commodity reading section 110 reads a commodity image through the image capturing section 164 when the customer puts the code symbol attached to a commodity in front of the reading window 103 of the commodity reading section 110.

Further, a commodity placing table 203 for placing the unsettled commodity in a shopping basket is arranged at the right side of the main body 202, and, at the left side of the main body 202, a commodity placing table 204 for placing the settled commodity, a bag hook 205 for hooking a bag for placing the settled commodities therein and a temporary placing table 206 for placing the settled commodities temporarily before the settled commodities are put into a bag are arranged. The commodity placing tables 203 and 204 are provided with weighing scales 207 and 208 respectively, and are therefore capable of confirming whether or not the weight of commodities is the same before and after a settlement.

Further, a change machine 201 for inputting bill for settlement and outputting bill as change is arranged in the main body 202 of the self-checkout POS 200.

In the case in which the present invention is applied to the self-checkout POS 200 having such constitutions as described above, the self-checkout POS 200 functions as an information processing apparatus. Further, a single apparatus comprising the functions of the POS terminal 11 and the commodity reading apparatus 101 is not limited to the self-checkout POS 200 having the above-constitutions and it may be an apparatus without having weighing scales 207 and 208.

Further, in the embodiment above, the programs executed by each apparatus are pre-incorporated in the storage medium (ROM or storage section) of each apparatus, however, the present invention is not limited to this, the programs may be recorded in a computer-readable recording medium such as CD-ROM, flexible disk (FD), CD-R, DVD (Digital Versatile Disk) in the form of installable or executable file. Further, the storage medium, which is not limited to a medium independent from a computer or an incorporated system, further includes a storage medium for storing or temporarily storing the downloaded program transferred via a LAN or the Internet.

In addition, the programs executed by each apparatus described in the embodiments above may be stored in a computer connected with a network such as the Internet to be provided through a network download or distributed via a network such as the Internet.

Alternatively, the programs mentioned in the embodiments above may be incorporated in a portable information terminal such as a mobile phone having a communication function, a smart phone, a PDA (Personal Digital Assistant) and the like to realize the functions of the programs.

What is claimed is:

1. An information processing apparatus, comprising:
an extraction module configured to extract a feature amount from an image of a commodity captured by an image capturing module;
a calculation module configured to compare the feature amount of each commodity registered in a dictionary in association with instruction information instructing whether or not to execute an automatic determination with the feature amount extracted by the extraction module to calculate a similarity degree therebetween;
a recognition module configured to recognize a commodity of which the similarity degree is higher than a threshold value as a commodity candidate from the commodities registered in a dictionary;
a determination module configured to determine the instruction information associated with the commodity candidate; and
a display control module configured to display each commodity candidate recognized by the recognition module in a selectable manner if it is determined that the instruction information instructing not to execute the automatic determination is associated.

2. The information processing apparatus according to claim 1, wherein
the instruction information is associated with each group in which a plurality of commodities having a specific relationship are grouped, and
the determination module determines the instruction information associated with the group to which the commodity candidate having the highest similarity degree belongs.

3. The information processing apparatus according to claim 1, wherein
the instruction information instructing the execution of the automatic determination is associated with the commodities of which the success rate of recognition by the recognition module is higher than a given value or a group consisting of the commodities.

4. The information processing apparatus according to claim 1, further comprising:
operation modes including an automatic determination execution mode for executing automatic determination and an automatic determination non-execution mode for not executing automatic determination for the commodity of which the execution of automatic determination is instructed by the instruction information; wherein
in the automatic determination non-execution mode, the display control module displays each commodity candidate recognized by the recognition module in a selectable manner regardless of the determination result of the determination module.

5. The information processing apparatus according to claim 1, further comprising:
a setting change module configured to change the instruction content of the instruction information associated with the commodity corresponding to the commodity candidate based on the recognition rate of the commodity candidate by the recognition module.

6. An information processing method, including:
extracting a feature amount from an image of a commodity captured by an image capturing module;
comparing the feature amount of each commodity registered in a dictionary in association with instruction information instructing whether or not to execute an automatic determination with the extracted feature amount to calculate a similarity degree therebetween;
recognizing a commodity of which the similarity degree is higher than a threshold value as a commodity candidate from the commodities registered in a dictionary;
determining the instruction information associated with the commodity candidate; and
displaying each recognized commodity candidate in a selectable manner if it is determined that the instruction information instructing not to execute the automatic determination is associated.
